(19) United States
(12) Patent Application Publication
(10) Pub. No.: US 2020/0050858 A1
(43) Pub. Date: Feb. 13, 2020

(54) METHOD AND APPARATUS OF PROVIDING INFORMATION ON ITEM IN VEHICLE

(71) Applicant: LG ELECTRONICS INC., Seoul (KR)

(72) Inventors: Jungkyun JUNG, Seoul (KR); Gyeonghun RO, Seoul (KR); Jungyong LEE, Seoul (KR)

(73) Assignee: LG ELECTRONICS INC., Seoul (KR)

(21) Appl. No.: 16/546,138

(22) Filed: Aug. 20, 2019

(30) Foreign Application Priority Data
Jun. 17, 2019 (KR) 10-2019-0071812

(51) Int. Cl. G06K 9/00; H04W 4/40; G06K 9/62; G06N 3/04; G06N 3/08

(52) U.S. Cl. CPC G06K 9/00671; G06K 9/00832; G06N 3/08; G06K 9/6262; G06N 3/04; H04W 4/40

(57) ABSTRACT

One or more of an autonomous vehicle, a user terminal, and a server disclosed herein is able to realize connection or fusion with an artificial intelligence module, an unmanned aerial vehicle (UAV), a robot, an augmented reality (AR) device, a virtual reality (VR) device, and a 5G service device, for example. In order to address the objects described above, a method of providing information from an operating apparatus according to an embodiment of the present disclosure includes acquiring image information on an inside of a vehicle, identifying information on an item placed inside the vehicle by a user based on the image information, and identifying information for an target for providing information based on the identified information on an item.

### CROSS-REFERENCE TO RELATED APPLICATION

Pursuant to 35 U.S.C. § 119(a), this application claims the benefit of earlier filing date and right of priority to Korean Patent Application No. 10-2019-0071812, filed on Jun. 17, 2019, the contents of which are hereby incorporated by reference herein in its entirety.

### BACKGROUND

### 1. Field

Embodiments of the present disclosure relate to a method and apparatus of providing information on an item in a vehicle to a user. More particularly, embodiments of the present disclosure relate to a method and apparatus of identifying an item and information regarding the item via a vehicle-inside image, and based on the identified result, providing a user with information on the item.

### 2. Description of the Related Art

Normally, when using a vehicle, a user may get in the vehicle with an item, and may store the item inside the vehicle if necessary. In such a case, since whether or not the item is stored is determined only by the user's memory, the user may leave the item inside the vehicle and get off, or the item may be stored inside the vehicle for an excessively long period of time. Such a problem may occur more frequently when using public transportation or sharing vehicles than when using private vehicles. For this reason, the need for a method and apparatus which are capable of identifying information on an item in a vehicle and providing a user with the identified information on the item is increasing.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Aspects of the present disclosure are to address the above-described problem, and an object of one embodiment of the present disclosure is to provide a method and apparatus which are capable of identifying information on an item inside a vehicle based on vehicle-inside image information and providing the information to a user in response to the user's need.

In accordance with an aspect of the present disclosure, a method and apparatus are provided. The method and apparatus are capable of providing a user with additional information regarding an item based on identified information on the item and information acquired from an external source, such as weather or the user's schedule.

In accordance with an aspect of the present disclosure, a method and apparatus are provided. The method and apparatus are capable of determining whether or not to provide information based on information on an item and a user to selectively provide the information to the user.

In accordance with another of the present disclosure, a method and apparatus are provided. The method and apparatus are capable of providing information necessary to transfer an item in a vehicle to a user via autonomous driving based on identified information on the item and user information.

In accordance with another of the present disclosure, a method of providing information from an operating apparatus according to an embodiment of the present disclosure includes acquiring image information on an inside of a vehicle, identifying information on an item placed inside the vehicle by a user based on the image information, and identifying information for an target for providing information based on the identified information on the item.

In accordance with another of the present disclosure, an operating apparatus according to another embodiment of the present disclosure includes a communication unit configured to communicate with another apparatus and a controller configured to acquire image information on an inside of a vehicle, to identify information on an item placed inside the vehicle by a user based on the image information, and to identify information for an target for providing information based on the identified information on the item.

In accordance with another of the present disclosure a non-volatile storage medium according to a further embodiment of the present disclosure includes an instruction that performs acquisition of image information on an inside of a vehicle, identification of information on an item placed inside the vehicle by a user based on the image information, and identification of information for an target for providing information based on the identified information on the item.

In accordance with another of the present disclosure, the embodiments of the present disclosure have a feature in that information on an item in a vehicle may be identified and the identified information may be selectively provided to a user. According to the embodiments of the present disclosure, it is possible to effectively provide a user with information on an item in a vehicle by additionally considering information which may be identified from the outside of the vehicle. According to the embodiments of the present disclosure, it is possible to provide information regarding a place where an item in a vehicle may be transferred to a user via autonomous driving of the vehicle in consideration of information on the user and the item in the vehicle.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device according to an embodiment of the present disclosure.

FIG. 2 illustrates an AI server according to an embodiment of the present disclosure.

FIG. 3 illustrates an AI system according to an embodiment of the present disclosure.

FIG. 4 illustrates an example of a basic operation of an autonomous vehicle and a 5G network in a 5G communication system.

FIGS. 5A to 5D are views for explaining a method of identifying a user and an item based on an image of a seat area in a vehicle.

FIG. 6 is a view for explaining a method of identifying an item based on an image of a trunk area in a vehicle.

FIG. 7 is a flowchart for explaining a method of identifying an item based on vehicle-inside image information and providing a user with information regarding the identified item.

FIG. 8 is a flowchart for explaining a method of providing a user with information related to an item in a vehicle based on vehicle driving state information.

FIG. 9 is a flowchart for explaining a method of providing information regarding the case in which a user gets out of a vehicle based on information on an item in the vehicle.

FIGS. 10A and 10B are views for explaining a user interface (UI) that provides a user with information on an item in a vehicle.

FIG. 11 is a view for explaining a method of providing item-related information from public transportation to a user.

FIG. 12 is a flowchart for explaining a method of providing a user with item-related information based on information on an item in a vehicle and external environment information.

FIGS. 13A and 13B are views for explaining an UI that provides a user with item-related information based on information on an item in a vehicle and external environment information.

FIG. 14 is a flowchart for explaining a method of providing a user with item-related information based on information regarding the atmospheric temperature and the temperature inside a vehicle.

FIGS. 15A to 15C are reference views for explaining a method of providing a user with item-related information based on information regarding the atmospheric temperature and the temperature inside a vehicle and a view for explaining an UI.

FIG. 16 is a flowchart for explaining a method of transferring an item in a vehicle to a user via autonomous driving based on information on the item and information on the user.

FIGS. 17A and 17B are views for explaining an UI that transfers an item in a vehicle to a user via autonomous driving based on information on the item and information on the user.

FIG. 18 is a view for explaining a method of transferring information between respective nodes for providing information regarding an item in a vehicle in response to a user request.

FIG. 19 is a view for explaining a method of transferring information between respective nodes for providing information regarding an item in a vehicle via identifying by a vehicle controller.

FIG. 20 is a view for explaining a method of transferring information between respective nodes for collecting information on an item placed in a vehicle and providing the information.

FIG. 21 is a view for explaining a method of transferring information between respective nodes for providing a user with required information on the item in consideration of information on an item placed in a vehicle based on user schedule information.

FIG. 22 is a view for explaining a method of transferring information between respective nodes for proposing an item storage position in a vehicle in consideration of information on an item in the vehicle and weather information.

FIG. 23 is a view for explaining a vehicle according to an embodiment of the present disclosure.

FIG. 24 is a view for explaining an operating apparatus for the provision of information according to an embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Embodiments of the disclosure will be described hereinbelow with reference to the accompanying drawings. However, the embodiments of the disclosure are not limited to the specific embodiments and should be construed as including all modifications, changes, equivalent devices and methods, and/or alternative embodiments of the present disclosure. In the description of the drawings, similar reference numerals are used for similar elements.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may use corresponding components regardless of importance or an order and are used to distinguish a component from another without limiting the components. These terms may be used for the purpose of distinguishing one element from another element. For example, a first user device and a second user device may indicate different user devices regardless of the order or importance. For example, a first element may be referred to as a second element without departing from the scope the disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor (AP)) capable of performing a corresponding operation by executing one or more software programs stored in a memory device.

Exemplary embodiments of the present invention are described in detail with reference to the accompanying drawings.

Detailed descriptions of technical specifications well-known in the art and unrelated directly to the present invention may be omitted to avoid obscuring the subject matter of the present invention. This aims to omit unnecessary description so as to make clear the subject matter of the present invention.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

Artificial Intelligence refers to the field of studying artificial intelligence or a methodology capable of making the artificial intelligence. Machine learning refers to the field of studying methodologies that define and solve various problems handled in the field of artificial intelligence. Machine learning is also defined as an algorithm that enhances the performance of a task through a steady experience with respect to the task. In the embodiments of the present disclosure, artificial intelligence may be applied to the case of identifying an item via vehicle-inside image analysis, the case of identifying a required item based on user schedule information, or the case of determining a position, to which an article is transferred, in consideration of a user's position, but is not limited thereto.

An artificial neural network (ANN) is a model used in machine learning, and may refer to a general model that is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output input signals that are input through the synapse, weights, and the value of an activation function concerning deflection.

Model parameters refer to parameters determined by learning, and include weights for synaptic connection and deflection of neurons, for example. Then, hyper-parameters mean parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function maybe used as an index for determining an optimal model parameter in a learning process of the artificial neural network.

Machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by an artificial neural network when learning data is input to the artificial neural network. The unsupervised learning may refer to a learning method for an artificial neural network in the state in which no label for learning data is given. The reinforcement learning may mean a learning method in which an agent defined in a certain environment learns to select a behavior or a behavior sequence that maximizes cumulative compensation in each state.

Machine learning realized by a deep neural network (DNN) including multiple hidden layers among artificial neural networks is also called deep learning, and deep learning is a part of machine learning. Hereinafter, machine learning is used as a meaning including deep learning.

The term “autonomous driving” refers to a technology of autonomous driving, and the term “autonomous vehicle” refers to a vehicle that travels without a user's operation or with a user's minimum operation.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

A vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

At this time, an autonomous vehicle may be seen as a robot having an autonomous driving function.

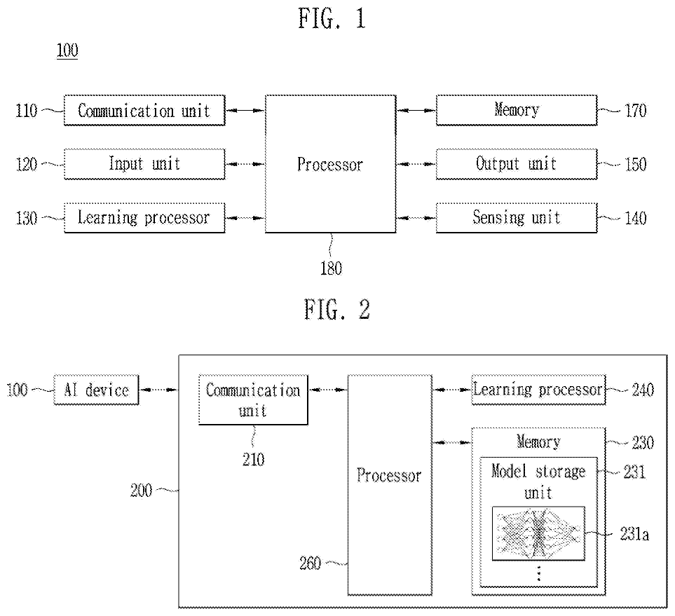

FIG. 1 illustrates an AI device 100 according to an embodiment of the present disclosure.

AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle. In the embodiment, the AI device may be included in an operating apparatus that analyzes an image and provides information to a user.

Referring to FIG. 1, Terminal 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device. In the embodiment, learning processor 130 may determine at least one of a user and an item via analysis of a vehicle-inside image.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of AI device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

FIG. 2 illustrates AI server 200 according to an embodiment of the present disclosure.

Referring to FIG. 2, AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

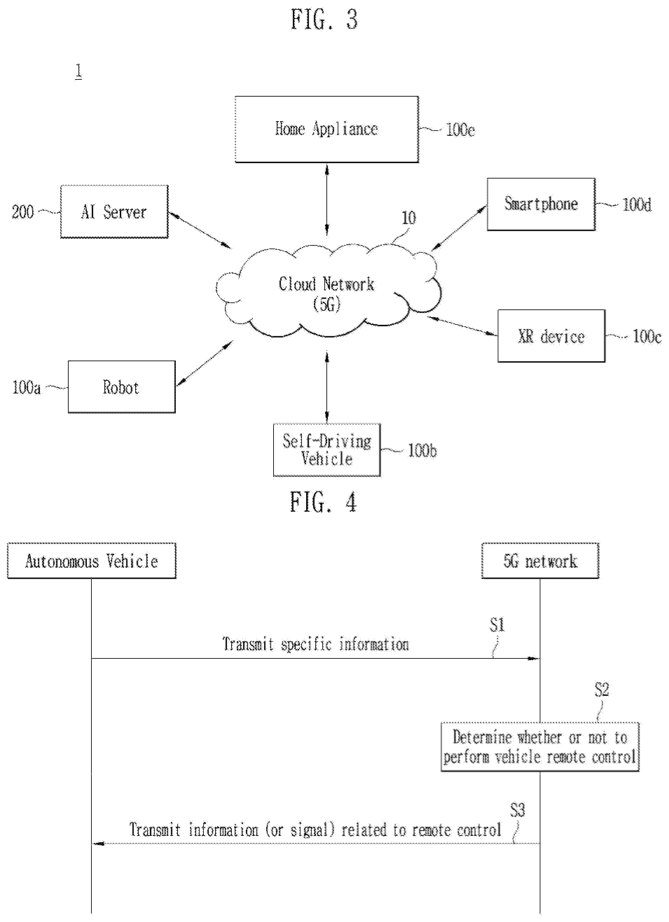

FIG. 3 illustrates an AI system 1 according to an embodiment of the present disclosure.

Referring to FIG. 3, in AI system 1, at least one of AI server 200, a robot 100a, an autonomous driving vehicle 100b, an XR device 100c, a smart phone 100d, and a home appliance 100e is connected to a cloud network 10. Here, robot 100a, autonomous driving vehicle 100b, XR device 100c, smart phone 100d, and home appliance 100e, to which AI technologies are applied, may be referred to as AI devices 100a to 100e.

Cloud network 10 may constitute a part of a cloud computing infra-structure, or may mean a network present in the cloud computing infra-structure. Here, cloud network 10 may be configured using a 3G network, a 4G or long term evolution (LTE) network, or a 5G network, for example.

That is, respective devices 100a to 100e and 200 constituting AI system 1 may be connected to each other via cloud network 10. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous driving vehicle 100b, XR device 100c, smart phone 100d, and home appliance 100e, which are AI devices constituting AI system 1, via cloud network 10, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

Hereinafter, various embodiments of AI devices 100a to 100e, to which the above-described technology is applied, will be described. Here, AI devices 100a to 100e illustrated in FIG. 3 may be specific embodiments of AI device 100 illustrated in FIG. 1.

Autonomous driving vehicle 100b may be realized into a mobile robot, a vehicle, or an unmanned air vehicle, for example, through the application of AI technologies.

Autonomous driving vehicle 100b may include an autonomous driving control module for controlling an autonomous driving function, and the autonomous driving control module may mean a software module or a chip realized in hardware. The autonomous driving control module may be a constituent element included in autonomous driving vehicle 100b, but may be a separate hardware element outside autonomous driving vehicle 100b so as to be connected to autonomous driving vehicle 100b.

Autonomous driving vehicle 100b may acquire information on the state of autonomous driving vehicle 100b using sensor information acquired from various types of sensors, may detect (recognize) the surrounding environment and an object, may generate map data, may determine a movement route and a driving plan, or may determine an operation. In the embodiment, autonomous driving vehicle 100b may determine a position at which an item inside the vehicle is to be transferred to a user, and may provide the information to the user.

Here, autonomous driving vehicle 100b may use sensor information acquired from at least one sensor among a lidar, a radar, and a camera in the same manner as robot 100a in order to determine a movement route and a driving plan.

In particular, autonomous driving vehicle 100b may recognize the environment or an object with respect to an area outside the field of vision or an area located at a predetermined distance or more by receiving sensor information from external devices, or may directly receive recognized information from external devices.

Autonomous driving vehicle 100b may perform the above-described operations using a learning model configured with at least one artificial neural network. For example, autonomous driving vehicle 100b may recognize the surrounding environment and the object using the learning model, and may determine a driving line using the recognized surrounding environment information or object information. Here, the learning model may be directly learned in autonomous driving vehicle 100b, or may be learned in an external device such as AI server 200.

At this time, autonomous driving vehicle 100b may generate a result using the learning model to perform an operation, but may transmit sensor information to an external device such as AI server 200 and receive a result generated by the external device to perform an operation.

Autonomous driving vehicle 100b may determine a movement route and a driving plan using at least one of map data, object information detected from sensor information, and object information acquired from an external device, and a drive unit may be controlled to drive autonomous driving vehicle 100b according to the determined movement route and driving plan.

The map data may include object identification information for various objects arranged in a space (e.g., a road) along which autonomous driving vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous driving vehicle 100b may perform an operation or may drive by controlling the drive unit based on user control or interaction. At this time, autonomous driving vehicle 100b may acquire interactional intention information depending on a user operation or voice expression, and may determine a response based on the acquired intention information to perform an operation.

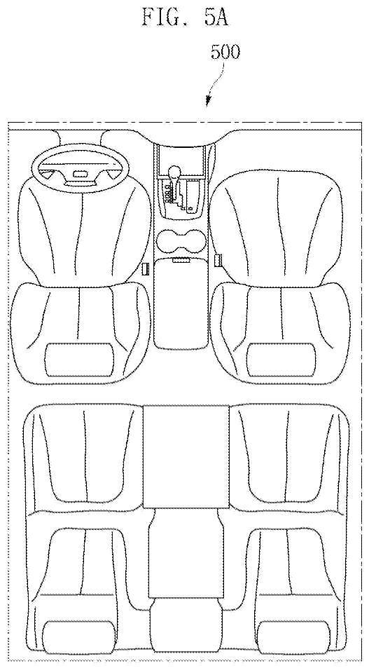

FIG. 4 illustrates an example of a basic operation of an autonomous vehicle and a 5G network in a 5G communication system.

In step S1, the autonomous vehicle transmits specific information to the 5G network.

The specific information may include information regarding autonomous driving.

The information regarding autonomous driving may be information directly related to vehicle driving control. For example, the information regarding autonomous driving may include one or more of object data indicating an object around a vehicle, map data, vehicle state data, vehicle location data, and driving plan data.

In step S2, the information regarding autonomous driving may further include, for example, service information required for autonomous driving. For example, the specific information may include information regarding a destination input via a user terminal and a vehicle stability grade. Then, the 5G network may determine whether or not to perform vehicle remote control.

Here, the 5G network may include a server or a module which performs remote control related to autonomous driving.

Then, in step S3, the 5G network may transmit information (or signals) regarding remote control to the autonomous vehicle.

As described above, the information regarding remote control may be signals directly applied to the autonomous vehicle, and may further include service information required for autonomous driving. In an embodiment of the present disclosure, the autonomous vehicle may provide a service related to autonomous driving by receiving service information such as insurance for each selected section on a driving route and a dangerous section via a server connected to the 5G network. In addition, in the embodiment, information on a location determined in the operating apparatus may be provided to the vehicle via the 5G network, and the vehicle may perform autonomous driving based on the provided information. In addition, the information regarding autonomous driving may be provided to a user during autonomous driving.

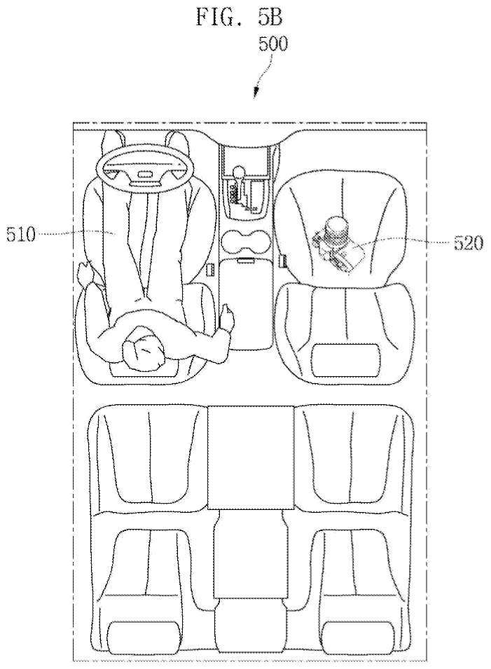

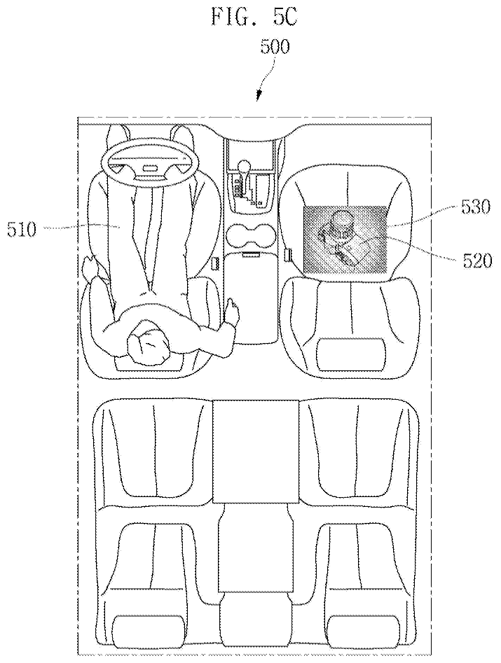

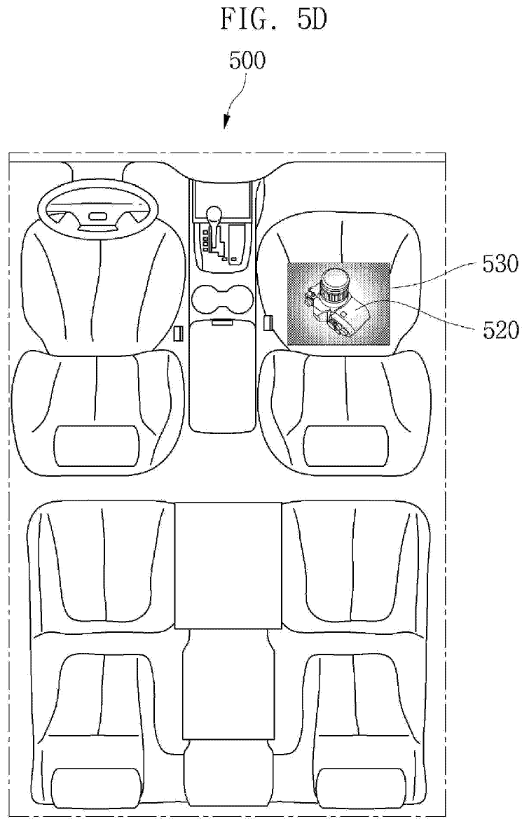

FIGS. 5A to 5D are views for explaining a method of identifying a user and an item based on an image of a seat area inside a vehicle.

FIGS. 5A to 5D illustrate a method of identifying a user and an item based on image information on seats in a vehicle.

In FIG. 5A, a vehicle-inside image 500 is illustrated. In the embodiment, an item placed originally inside a vehicle may be identified based on image information. Thereafter, based on a change in the image, a user and an item put in the vehicle by the user may be identified. In addition, in the embodiment, when it is determined based on image information that the originally placed item disappears, the placed item corresponding to a disappeared image may be identified and information related thereto may be provided to the user. In this way, in the embodiment, the operating apparatus may repeatedly acquire vehicle-inside image information, and may identify an item placed newly in the vehicle or an item removed from the vehicle based on a change in the image information. In addition to the item, in some embodiments, the operating apparatus may also identify whether or not the inside of the vehicle is contaminated and the degree of contamination by analyzing the image information. In addition, in the embodiment, the operating apparatus may identify the item and the user which are present in a vehicle-inside photograph via machine learning without comparison with a previously acquired image.

In FIG. 5B, a user 510 gets in the vehicle with a camera 520. At this time, the operating apparatus may identify user 510 and camera 520.

FIG. 5C is a view illustrating a method of identifying camera 520. The operating apparatus may recognize a camera periphery area 530, and may conduct in-depth analysis of an image of the area. Through such in-depth analysis of the image, the operating apparatus may identify at least one of the type of an item in the image, the characteristics of the item, the time when the item is put in the vehicle, and the time when the item is removed from the vehicle.

FIG. 5D illustrates the situation in which user 510 leaves camera 520 inside the vehicle. In this case, the operating apparatus may perform an operation according to an embodiment which will be described below. In an example of the operation, the operating apparatus may provide the user with a warning that notifies the user about that the user leaves camera 520 in the vehicle, or may propose a position at which camera 520 is stored.

In the embodiment, one or more cameras may be used to capture the vehicle-inside image. When multiple cameras are used, images acquired from the respective cameras may be identified respectively, or image identification may be performed based on a composite image after combining the images with each other.

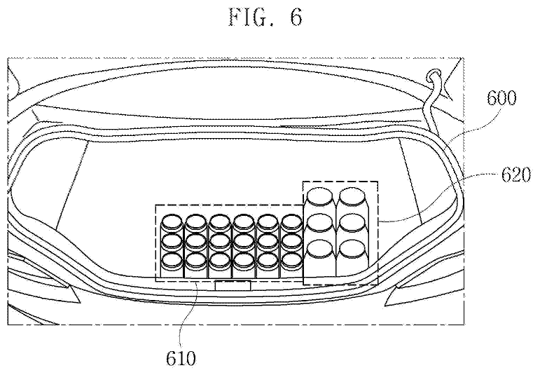

FIG. 6 is a view for explaining a method of identifying an item based on an image of a trunk area in a vehicle.

Referring to FIG. 6, an image of a trunk area in a vehicle is illustrated.

In the embodiment, the operating apparatus may identify a coke 610 and a jam 620 inside a trunk 600. As described in the above embodiment, these items may be identified based on a trunk image. In addition, in the embodiment, the operating apparatus may also determine the characteristics of the identified items. In one example, the operating apparatus may identify information indicating that coke 610 is a carbonated beverage and has a risk of bursting when stored at high room temperatures. In addition, in another example, the operating apparatus may identify information indicating that jam 620 may deteriorate when stored in a high-temperature environment for a long period of time. In this way, the operating apparatus may grasp the characteristics of information on an item to be identified from an image.

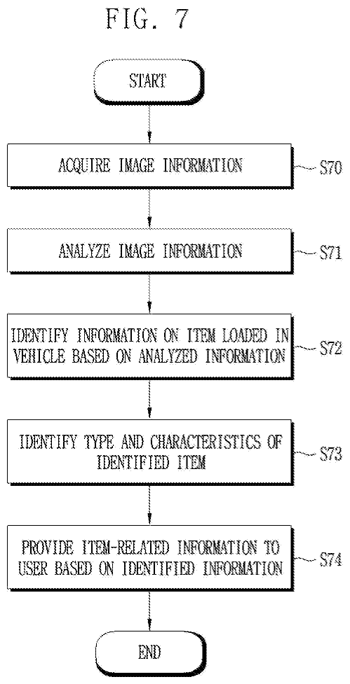

FIG. 7 is a flowchart for explaining a method of identifying an item based on vehicle-inside image information and providing a user with information regarding the identified item.

Referring to FIG. 7, there is illustrated a method of identifying an item based on image information and providing a user with information regarding the identified item by the operating apparatus.

In step S70, the operating apparatus may acquire vehicle-inside image information. In the embodiment, the image information may be received from a camera unit which is located in a seat area and a trunk area in a vehicle. In addition, in some embodiments, image information may also be received from a camera in a storage space of the vehicle.

In step S71, the operating apparatus may analyze the received image information. In the embodiment, the operating apparatus may analyze an image by comparing images collected several times and determining a difference between the images. In addition, in the embodiment, the operating apparatus may determine, for example, meaningful information on the item, user information, and vehicle contamination information via machine learning using the collected images.

In step S72, the operating apparatus may identify information on an item placed in the vehicle based on the analyzed information. More specifically, the operating apparatus may identify whether or not an item is placed in a specific area via image identification.

In step S73, the operating apparatus may identify at least one of the type and characteristics of the item based on the identified information on the item. In addition, the operating apparatus may further determine the presence of a user or whether or not the inside of the vehicle is contaminated as mentioned above, in addition to the item. In the embodiment, determining the presence of a user or whether or not the inside of the vehicle is contaminated may be useful, for example, in the case of determining whether or not a specific user has contaminated a sharing vehicle. In addition, in the embodiment, the user information may be identified based on payment information in the case of a sharing vehicle or public transportation, in addition to the image information.

In step S74, the operating apparatus may provide a user with information related to the item placed inside the vehicle based on information such as the identified type and characteristics of the item. More specifically, the operating apparatus may provide information regarding whether or not the item is inside the vehicle in response to a user request. In addition, in some embodiments, the operating apparatus may determine whether or not to notify the user of the information related to the item placed in the vehicle based on information acquired from an external device, and may provide the information to the user. In addition, an operation of the operating apparatus which will be described in the following embodiment may be executed with reference to the present embodiment.

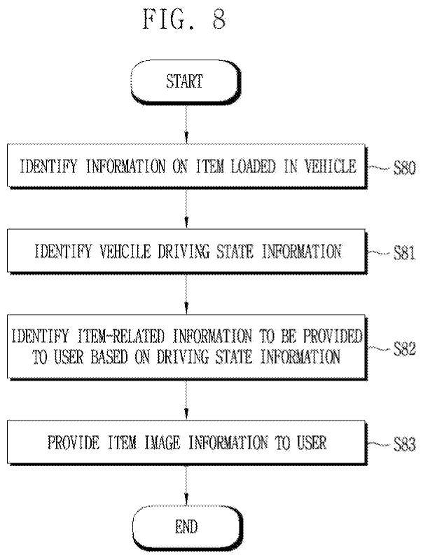

FIG. 8 is a flowchart for explaining a method of providing a user with information related to an item in a vehicle based on vehicle driving state information.

Referring to FIG. 8, there is illustrated a method of providing a user with information related to an item based on information on the item loaded in a vehicle and vehicle driving state information by the operating apparatus.

In step S80, the operating apparatus may identify information on an item loaded in a vehicle. In the embodiment, the operating apparatus may identify information on the item placed in the vehicle based on image information from the camera unit of the vehicle.

In step S81, the operating apparatus may identify vehicle driving state information. More specifically, the driving state information may include at least one of the state of a road on which the vehicle drives, the speed of the vehicle, and driving information of a peripheral vehicle. In addition, the vehicle driving state information may include information regarding whether or not rapid acceleration, speed reduction, or redirection has occurred based on the past driving record of the vehicle. The reason why the operating apparatus identifies the driving state information is because the item loaded in the vehicle may shake or fall down according to the driving state of the vehicle.

In step S82, the operating apparatus may identify information related to the item to be provided to the user based on the information identified in step S80 and step S81. More specifically, the information related to the item may be identified in response to a user request. In addition, the information related to the item may be identified even when the driving state information satisfies a preset condition. The preset condition may include the case in which acceleration applied to the item loaded in the vehicle becomes a predetermined value or more due to vehicle driving. In addition, the information related to the item may be identified even when a condition for changing the loading state of the item is satisfied.

In step S83, the operating apparatus may provide the user with image information regarding the item. The image information may be image information on a position specified by the user, image information selected by the operating apparatus, image information on all positions at which items are loaded inside the vehicle, or image information on a position at which the loading state of the item is changed, and combinations of the image information may be provided.

Through the embodiment described above, when the loading state of the item inside the vehicle is changed during driving due to the driving environment, the user may receive related image information. In addition, the image information may be provided via at least one of a terminal carried by the user or a vehicle display. In addition, since the image information is acquired based on at least one of the driving state information and the information on the loaded item, acquisition of a larger amount of image information than necessary may be suppressed. Since it is possible to determine whether or not to provide the user with the information related to the item based on at least one of the aforementioned pieces of image information, the user may obtain improved usability.

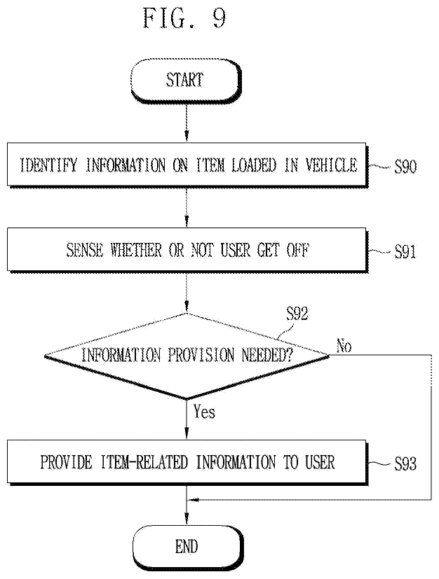

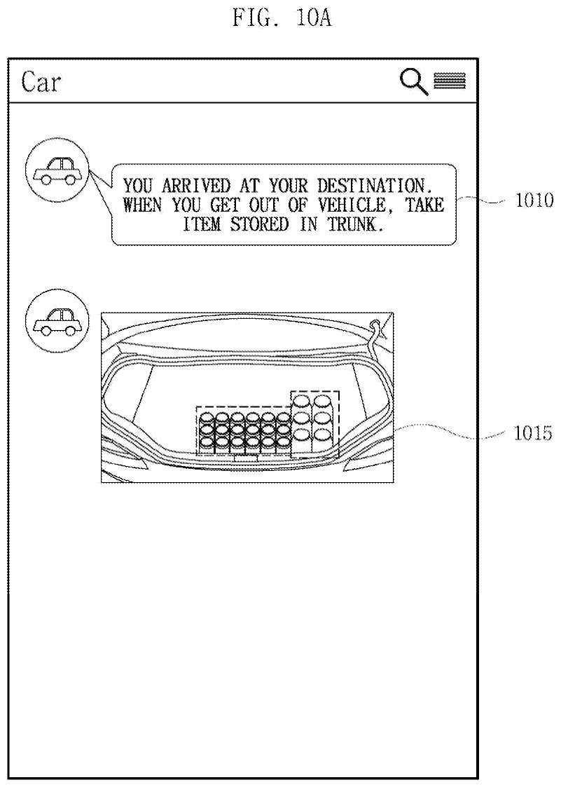

FIG. 9 is a flowchart for explaining a method of providing information regarding the case in which a user gets out of a vehicle based on information on an item in the vehicle.

Referring to FIG. 9, there is illustrated a method of identifying information on an item loaded in a vehicle, sensing whether or not a user gets out of the vehicle, and providing the user with the information regarding the item based on the sensed result by the operating apparatus. The present embodiment may be usefully applied to public transportation or a sharing vehicle, without a limitation thereto.

In step S90, the operating apparatus may identify information on an item loaded in a vehicle. In the embodiment, the operating apparatus may identify information on the item loaded in the vehicle based on image information from the camera unit of the vehicle. In addition, in the embodiment, the operating apparatus may sense a user corresponding to the item loaded in the vehicle. In some embodiments, the sensed user corresponding to the item may be a user who gets in the vehicle with the item. In addition, in some embodiments, a user who has the largest area overlapping the item on an image may be determined as the sensed user corresponding to the item.

In step S91, the operating apparatus may sense whether or not the user gets out of the vehicle. Whether or not the user gets out of the vehicle may be determined based on a vehicle-inside image. In addition, whether or not the user gets out of the vehicle may be sensed in association with whether or not a vehicle door is opened and closed.

In step S92, the operating apparatus may determine whether or not it is necessary to provide information according to whether or not the user gets out of the vehicle. More specifically, when the item corresponding to the user is inside the vehicle, the operating apparatus may determine that it is necessary to provide information to the user. In addition, in some embodiments, the operating apparatus may determine whether or not it is necessary to provide information based on the environment of a location where the user gets out of the vehicle or a relationship between the user and the get-off location. In one example, when the user gets in the vehicle with a laptop computer, and then gets out of the vehicle at a location identified as the place of work, the operating apparatus may determine whether or not it is necessary to provide information to the user based on at least one of the get-off location and user schedule information. In addition, when the user leaves an umbrella in the vehicle and the weather forecast says it will rain, the vehicle may determine that it is necessary to provide the user with information related to the umbrella. In addition, when the vehicle is public transportation, information on an item that the user lefts may be provided at a higher frequency. More specifically, since public transportation such as a bus or a taxi provides an environment in which it is difficult for the user to again get in the vehicle, it may be necessary to immediately issue a warning when the user lefts an item in the vehicle. In the embodiment, the immediate provision of the warning may be executed via at least one of vehicle Klaxon, an announcement, provision of related information via a vehicle display, and provision of related information to a user terminal.

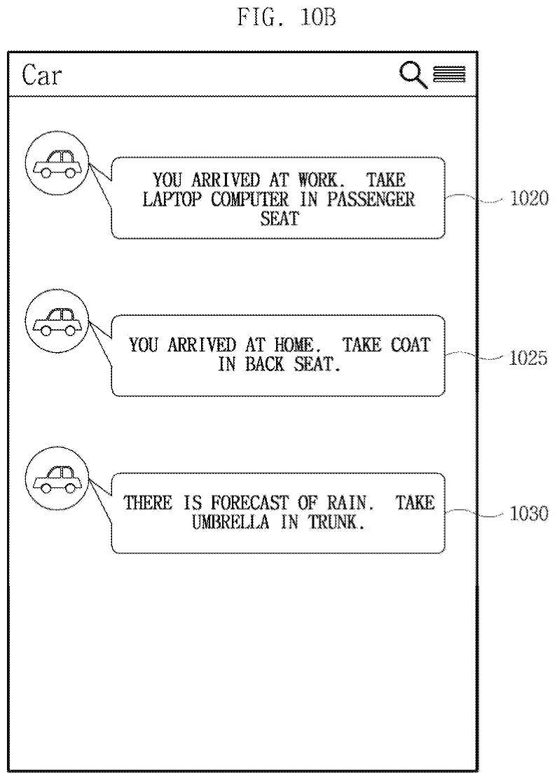

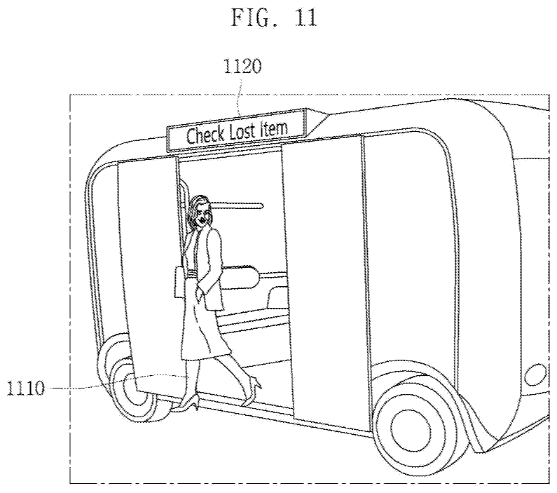

FIGS. 10A and 10B are views for explaining a user interface (UI) that provides a user with information on an item in a vehicle.

Referring to FIGS. 10A and 10B, an UI for item-related information to be provided to a user terminal is illustrated.

In the embodiment, when a vehicle arrives at a destination in the state in which a coke and a jam are loaded in a trunk, the operating apparatus may determine whether or not a user needs to take the loaded items off the vehicle based on the characteristics of the loaded items. In one example, when the vehicle arrives at home, the possibility that the user takes the items off the vehicle is high, and the operating apparatus may provide the user with information designated by reference numeral 1010. In addition, the operating apparatus may additionally display a corresponding image 1015 to indicate a target item. In addition, when a user of a sharing vehicle returns the vehicle, information on an item in the vehicle may be provided. In the embodiment, the operating apparatus may provide information regarding the position of the item via at least one of an image and a text.

In addition, in some embodiments, when the vehicle arrives at a destination where the user is likely to use an item in the vehicle, the operating apparatus may provide information regarding the item as designated by reference numeral 1020. In one example, the operating apparatus may determine that the user is likely to use a laptop computer at work based on user schedule information and may provide information related thereto.

In addition, in some embodiments, the operating apparatus may determine that the user needs to take an item off the vehicle and may provide information related thereto as designated by reference numeral 1025. In one example, the operating apparatus may provide such information based on at least one of information indicating that the item placed in the vehicle is a coat, information regarding the time when the coat was placed in the vehicle, weather information, and destination information.

In addition, in some embodiments, the operating apparatus may provide information proposing that the user needs to take an item stored in the vehicle. In one example, when at least one of a condition that the probability of rain is a preset value or more according to weather information, a condition that an umbrella is placed in the vehicle, and a condition that the user is not carrying the umbrella is satisfied, the operating apparatus may propose that the user takes the umbrella off the vehicle as designated by reference numeral 1030.

FIG. 11 is a view for explaining a method of providing item-related information from public transportation to a user.

Referring to FIG. 11, there is illustrated a scene in which a user 1110 gets out of public transportation such as a bus. At this time, the operating apparatus may identify whether or not an item corresponding to user 1110 is in the bus, and when it is identified that user 1110 drops the item, the operating apparatus may provide information related thereto. In one example, the operating apparatus may notify user 1110 about that the user has an item left in the vehicle via a vehicle display 1120. In addition, in some embodiments, the operating apparatus may notify the user about that the user has an item left in the vehicle via vehicle Klaxon or an announcement. In the embodiment, the information provided to user 1110 may include information indicating that the user has an item left in the vehicle and information on the item. In addition, in some embodiments, the operating apparatus may identify user 1110 using information on a payment method that the user used when getting in the public transportation, and may provide the information to a terminal of user 1110.

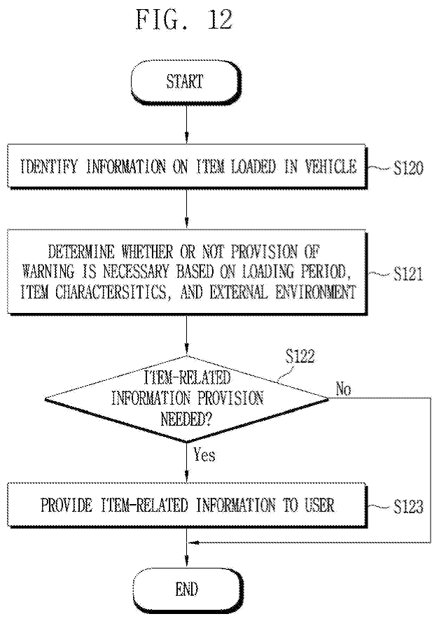

FIG. 12 is a flowchart for explaining a method of providing a user with item-related information based on information on an item in a vehicle and external environment information.

Referring to FIG. 12, there is illustrated a method of providing a user with information related to an item loaded in a vehicle based on information on the item and vehicle driving state information by the operating apparatus.

In step S120, the operating apparatus may identify information on an item loaded in a vehicle. In the embodiment, the operating apparatus may identify information on the item loaded in the vehicle based on image information from the camera unit of the vehicle.

In step S121, the operating apparatus may identify at least one of the loading period of the item, the characteristics of the item, and external environment information based on the identified information on the item, and may determine whether or not to provide item-related information based on the identified result. More specifically, the operating apparatus may provide this information when the item placed in the vehicle is likely to deteriorate at high temperatures and the outside temperature rises above a certain temperature. In addition, the operating apparatus may provide this information when the period during which the item is loaded in the vehicle satisfies a specific condition.

In step S122, the operating apparatus may determine whether or not it is necessary to provide information based on the information identified in step S121.

When it is determined that it is necessary to provide information, in step S123, the operating apparatus may provide item-related information to a user. In one example, the operating apparatus may provide at least one of information on the storage period of the item and information on the possibility of deterioration, along with the item-related information.

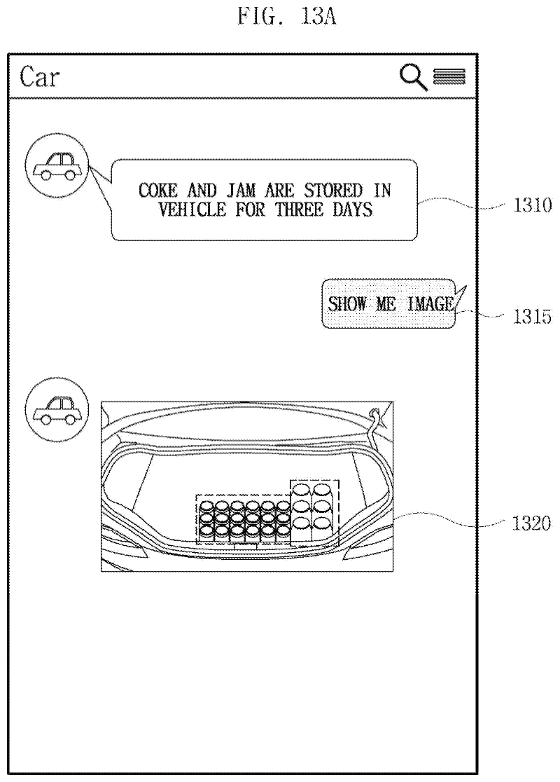

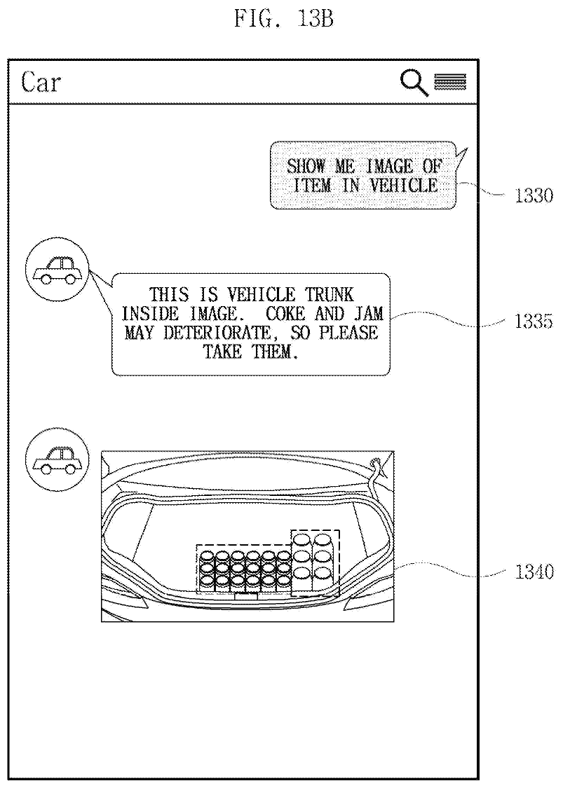

FIGS. 13A and 13B are views for explaining an UI that provides a user with item-related information based on information on an item in a vehicle and external environment information.

Referring to FIGS. 13A and 13B, there is illustrated an UI that provides item-related information via a user terminal by the operating apparatus. The user terminal is adopted in the embodiment, but the information may be provided via a vehicle display.

FIG. 13A is a view illustrating an embodiment in which information may be provided by triggering of the operating apparatus when the operating apparatus determines that it is necessary to provide item-related information.

More specifically, the operating apparatus may provide a user with information regarding the type of an item stored in a vehicle and the storage period of the item as designated by reference numeral 1310, and may provide an image of the item designated by reference numeral 1320 in response to a user request designated by reference numeral 1315. In some embodiments, both the reference numerals 1310 and 1320 may be provided together to the user.

FIG. 13B is a view illustrating an embodiment in which information may be provided by triggering in response to a user specific request when the operating apparatus determines that it is necessary to provide item-related information.

More specifically, when a user requests for an image of an item in a vehicle as designated by reference numeral 1330, the operating apparatus may provide item-related information designated by reference numerals 1335 and 1340. In some embodiments, the operating apparatus may selectively provide the item-related information.

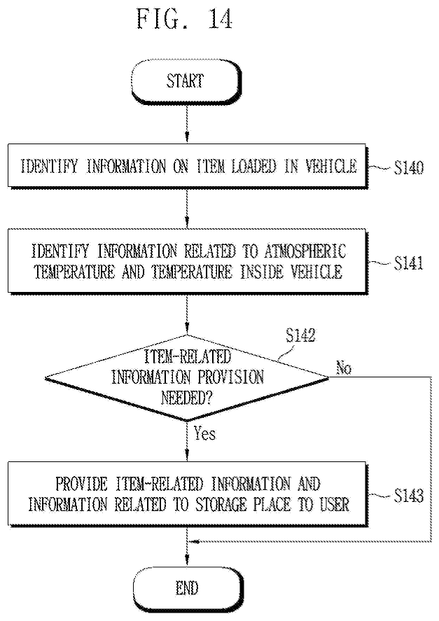

FIG. 14 is a flowchart for explaining a method of providing a user with item-related information based on information regarding the atmospheric temperature and the temperature inside a vehicle.

Referring to FIG. 14, there is illustrated a method of providing a user with item-related information based on information on an item loaded in a vehicle and vehicle driving state information by the operating apparatus.

In step S140, the operating apparatus may identify information on an item loaded in a vehicle. In the embodiment, the operating apparatus may identify information on the item loaded in the vehicle based on image information from the camera unit of the vehicle.

In step S141, the operating apparatus may identify information regarding the atmospheric temperature and the temperature inside the vehicle. More specifically, the operating apparatus may identify at least one of information on the atmospheric temperature and information on the temperature inside the vehicle using a vehicle temperature sensor, an external weather information server, and statistical data.

In step S142, the operating apparatus may determine whether or not it is necessary to provide information related to the item placed in the vehicle based on the above-described identified information. In one example, the operating apparatus may determine that it is necessary to provide item-related information when the item stored in the vehicle is vulnerable to high temperatures and the temperature inside the vehicle rises to a specific temperature or more or is expected to rise.

In step S143, when it is determined by the operating apparatus that it is necessary to provide a user with item-related information, the operating apparatus may provide the user with at least one of the item-related information and information on a place that is suitable for storing the item. In one example, the operating apparatus may propose to move the item to the outside of the vehicle or to move the item to a position inside the vehicle at which the temperature does not rise.

In addition, in some embodiments, the operating apparatus may propose an item storage place in the vehicle regardless of information on the atmospheric temperature or the temperature inside the vehicle. More specifically, when it is determined by the operating apparatus that an item with a high possibility of being stolen is located in a place where the item may be seen from the outside, the operating apparatus may perform an operation of proposing a storage place to the user.

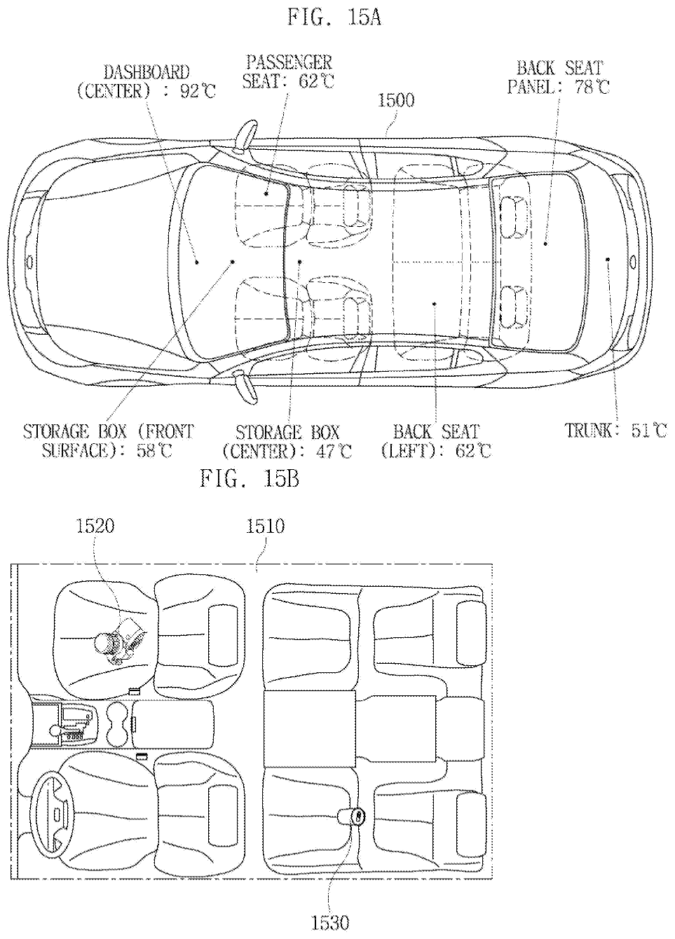

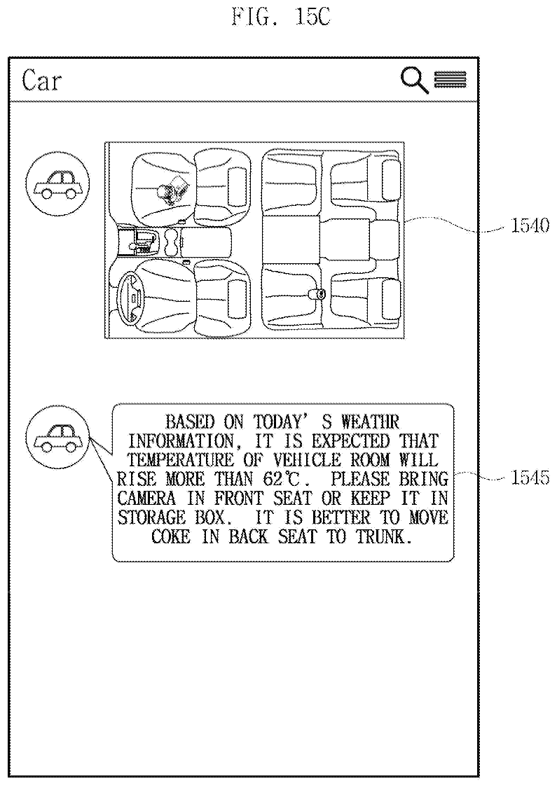

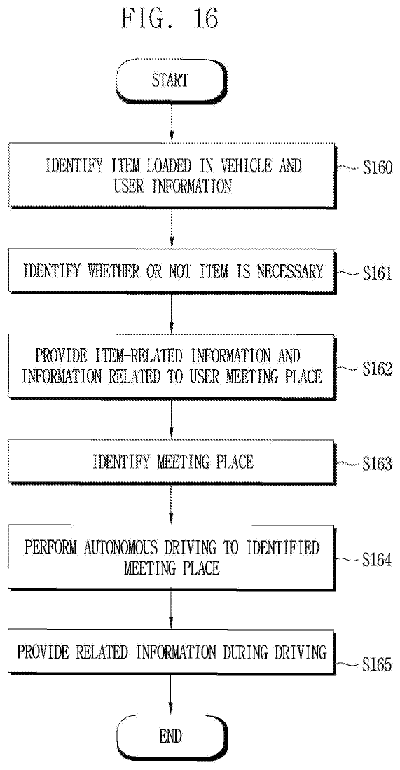

FIGS. 15A to 15C are reference views for explaining a method of providing a user with item-related information based on information on the atmospheric temperature and the temperature inside a vehicle and a view for explaining an UI.

FIG. 15A illustrates information on the temperatures at respective positions inside the vehicle on a clear day of a specific temperature. The operating apparatus may acquire information about how the temperature of each region of the vehicle changes based on information received from the weather information server and the parked position and the parked time of the vehicle. Based on the acquired information as described above, the operating apparatus may expect the distribution of the temperature inside the vehicle in the environment in which the vehicle is parked. In addition, in some embodiments, the operating apparatus may receive information regarding the distribution of the temperature inside the vehicle.

FIG. 15B is a view for explaining that a camera 1520 and a coke 1530 are placed in a vehicle room 1510. The operating apparatus may determine whether or not it is necessary to change the position of an item based on information on the expected temperature corresponding to the position at which the item is placed and specific information on the item. In addition, which it is necessary to change the position of the item, the operating apparatus may propose the position to which the item is to be moved. The movement position may be determined based on at least one of information on the characteristics of the item and information on the temperature at the movement position.

FIG. 15C is a view illustrating an UI that provides item-related information by determination of the operating apparatus. The operating apparatus may provide a user with at least one of item image information designated by reference numeral 1540 and related information designated by reference numeral 1545. In one example, the related information may include at least one of information on the expected temperature inside the vehicle, information on the item stored inside the vehicle, the necessity of a change in the position of the item, and the place to which the position of the item is changed.

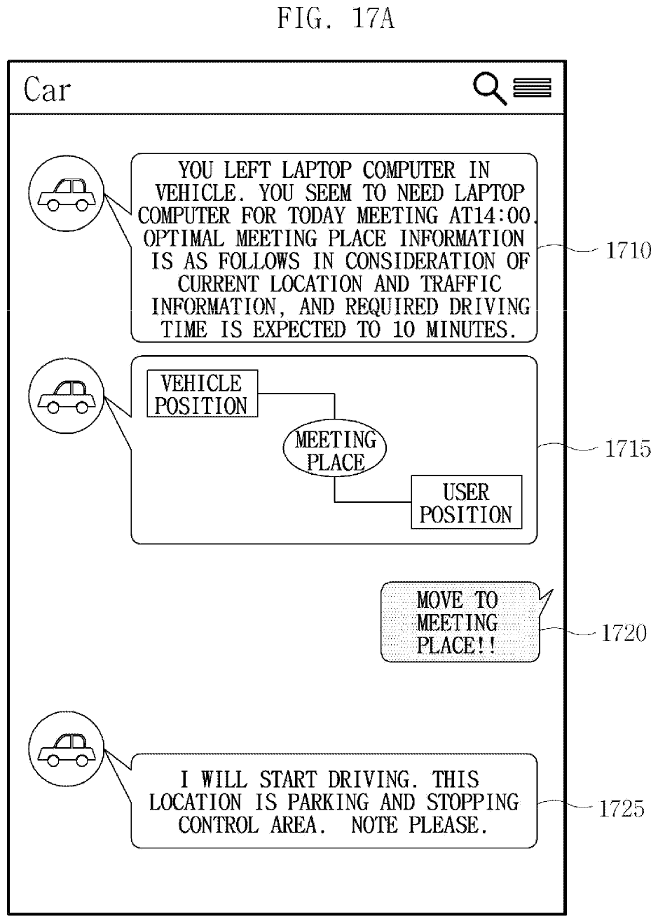

FIG. 16 is a flowchart for explaining a method of transferring an item in a vehicle to a user via autonomous driving based on information on the item and information on the user.

Referring to FIG. 16, there is illustrated a method of providing a user with item-related information based on information on an item loaded in a vehicle and vehicle driving state information by the operating apparatus.

In step S160, the operating apparatus may identify information on an item loaded in a vehicle. In the embodiment, the operating apparatus may identify information on the item loaded in the vehicle via image information received from the camera unit of the vehicle. In addition, the operating apparatus may identify information on the user based on at least one of the methods described in the previous embodiments. Meanwhile, the embodiment may correspond to the situation in which the user leaves the item in the vehicle and is away from the vehicle. In one example, the vehicle may be parked.

In step S161, the operating apparatus may identify whether or not the user requires the item. In one example, whether or not the user requires the item may be identified based on information regarding a user request for the item.

In another example, whether or not the user requires the item may be identified based on information on the item placed in the vehicle and user-related information, which are identified by the operating apparatus. More specifically, the user-related information may include at least one of user schedule information and user working environment information.

In step S162, the operating apparatus may provide the user with at least one of item-related information and information regarding the location where the vehicle and the user meet each other via autonomous driving based on the identified information. In the embodiment, the information may be transferred via communication between the operating apparatus and a user terminal. In one example, the item-related information may include at least one of information on the item loaded in the vehicle and schedule information corresponding to the item. In one example, the operating apparatus may propose, to the user, the location where the vehicle meets the user to transfer the item to the user via autonomous driving. The operating apparatus may propose the location where the vehicle meets the user based on at least one of the position of the vehicle, the position of the user, peripheral traffic information, and user schedule information.

In step S163, the operating apparatus may identify the location where the vehicle meets the user. In one example, the meeting location may be identified as the proposed location when the user approves the location proposed by the operating apparatus in the previous step. In another example, the meeting location may be separately designated by the user.

In step S164, the operating apparatus may move to the identified meeting location via autonomous driving. The embodiment is not limited as to a method of performing autonomous driving.

In step S165, the operating apparatus may provide related information. In one example, the related information may include information regarding the case in which the time required for the movement is changed according to a change in traffic situation. In another example, the related information may include information regarding traffic situation around a meeting place. When it is necessary to change a meeting place due to a change in traffic situation, for example, the operating apparatus may again propose a new meeting place based on the changed information, and may change the meeting place according to user selection.

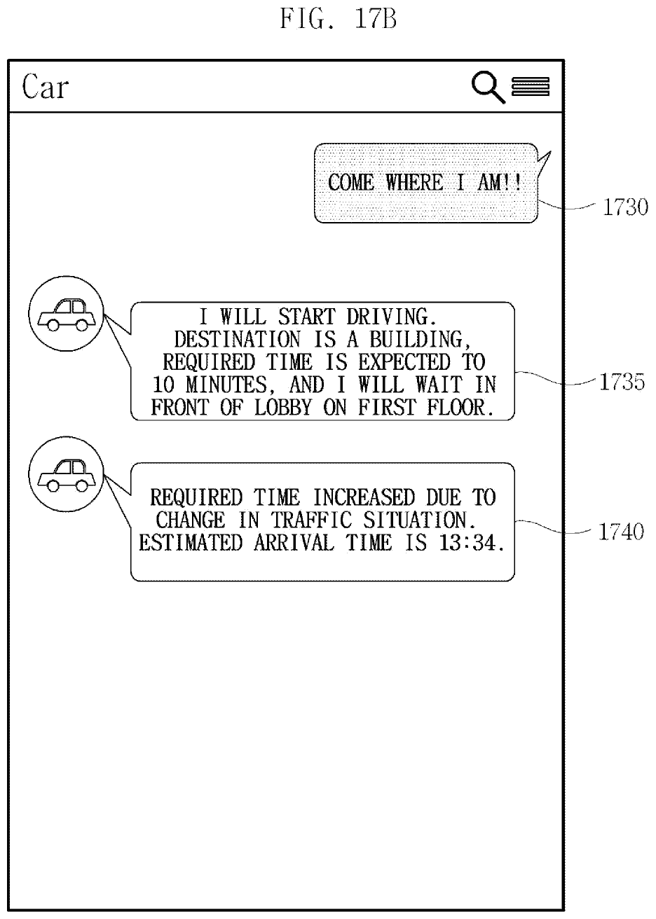

FIGS. 17A and 17B are views for explaining an UI that transfers an item in a vehicle to a user via autonomous driving based on information on the item and information on the user.

FIG. 17A illustrates an UI in which the operating apparatus identifies that an item inside a vehicle needs to be transferred to a user and thus provides the user with related information.

The operating apparatus may provide the user with at least one of information on the item, schedule information corresponding to the item, meeting place information, and movement time information as designated by reference numerals 1710 and 1715. In the embodiment, the meeting place information may be map image information including at least one of the position of the user, the position of the vehicle, and the position of the meeting place. In the embodiment, multiple meeting places may be proposed.

The user may transmit an instruction to the operating apparatus to call the vehicle to the meeting place proposed by the operating apparatus, as designated by reference numeral 1720. In the embodiment, the operating apparatus may grasp the meaning of the instruction based on natural language processing.

The operating apparatus may provide the user with information indicating that the vehicle begins to move in response to the user instruction, as designated by reference numeral 1725. In the embodiment, the operating apparatus may provide the user with meeting place information. The meeting place information may include information regarding traffic situation around the meeting place.

FIG. 17B illustrates an UI according to an alternative embodiment of the above-described embodiment with reference to FIG. 17A.

After a message designated by reference numeral 1715, the user may designate a separate place as designated by reference numeral 1730. In the embodiment, the user may input an instruction to move the vehicle to the position of the user via autonomous driving. The operating apparatus may identify the instruction via natural language processing.

The operating apparatus may provide the user with at least one of information on the position designated by the user and information on the time required for the movement, as designated by reference numeral 1735. In some embodiments, the operating apparatus may further provide destination information and information on the specific position of a destination. In addition, in some embodiments, the operating apparatus may provide the user with information on a route to the destination.

The operating apparatus may provide the user with additional information related to driving as designated by reference numeral 1740. In the embodiment, the additional information may include information on the changed time of arrival due to a change in traffic situation. In the embodiment, the time required for the movement may increase due to a change in traffic situation, and the changed time of arrival corresponding to the increased time may be provided.

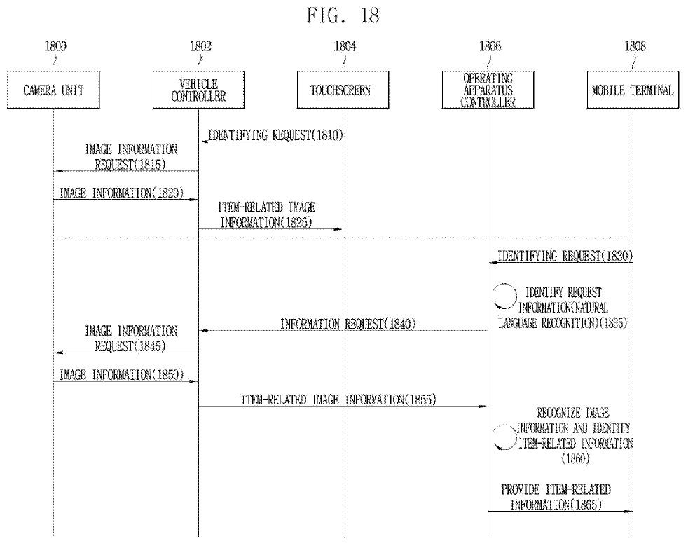

FIG. 18 is a view for explaining a method of transferring information between respective nodes for providing information regarding an item in a vehicle in response to a user request.

Referring to FIG. 18, there is illustrated a method of providing item-related information via information exchange between constituent elements 1800, 1802 and 1804 included in the vehicle, a controller 1806 of the operating apparatus, and a mobile terminal 1808 of the user.

Steps 1810 to 1825 explain a process in which the user receives item-related image information, captured by camera unit 1800, via touchscreen 1804 of the vehicle. More specifically, the process may be used in the environment in which the item is placed at a position inside the vehicle that is not visible to the user.

In step 1810, identifying request information may be transmitted to vehicle controller 1802 based on user input received via touchscreen 1804. In the embodiment, the identifying request information may be information related to the position inside the vehicle to be identified, and the information related to the position may indicate a camera at a specific position.

In step 1815, vehicle controller 1802 may request the corresponding camera unit 1800 for image information.

In step 1820, camera unit 1800 may transfer image information to vehicle controller 1802.

In step 1825, vehicle controller 1802 may transfer item-related image information to touchscreen 1804 to provide the image information to the user. Touchscreen 1804 may provide the received image to the user.

The embodiment described above may be used to allow the user to utilize an image of an item placed in a vehicle trunk, for example, via the touchscreen in the vehicle.

Steps 1830 to 1865 explain a process in which the user receives information related to the item in the vehicle via mobile terminal 1808. More specifically, the process may be used to allow the user to receive information related to the item inside the vehicle from the outside of the vehicle via mobile terminal 1808.

In step 1830, operating apparatus controller 1806 may receive a identifying request for identifying information on the item from mobile terminal 1808 of the user. In the embodiment, the identifying request may include information for specifying a target camera unit or information regarding whether or not a specific item is in the vehicle.

In step 1835, operating apparatus controller 1806 may identify the received request information. In the embodiment, the identifying request may be received in a general sentence form, and operating apparatus controller 1806 may identify the information via natural language processing.

In step 1840, operating apparatus controller 1806 may request vehicle controller 1802 for the related information based on the identified information. In the embodiment, the requested related information may include at least one of image information captured by a specific camera unit and image information regarding the region in which a specific item is placed.

In step 1845, vehicle controller 1802 may request corresponding camera unit 1800 for image information based on the received information request.

In step 1850, camera unit 1800 may transmit the requested image information to vehicle controller 1802.

In step 1855, vehicle controller 1802 may transfer the acquired item-related image information to operating apparatus controller 1806.

In step 1860, operating apparatus controller 1806 may identify item-related information based on the received image information, and may identify item-related information corresponding to the information requested by the user. In the embodiment, the position that the user requests, image information corresponding to an item that the user is looking for, and information related to the identified item may also be identified.

In step 1865, the operating apparatus controller may provide the item-related information to mobile terminal 1808.

In an embodiment, camera unit 1800 and vehicle controller 1802 may capture multiple images and transfer the images to operating apparatus controller 1806.

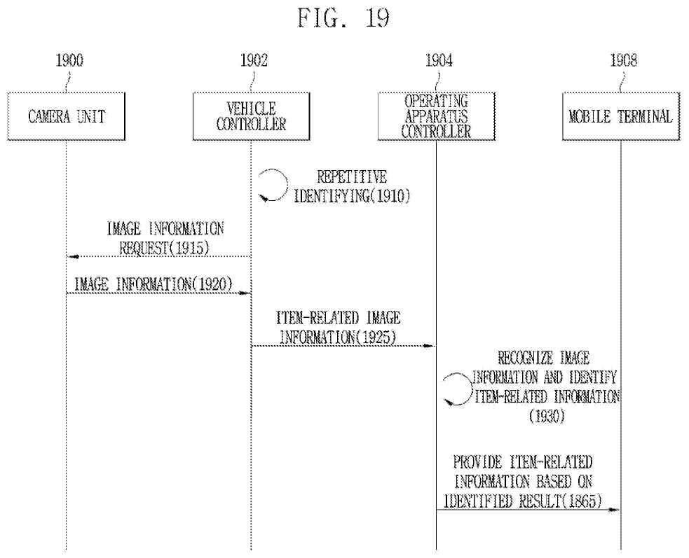

FIG. 19 is a view for explaining a method of transferring information between respective nodes for providing information regarding an item in a vehicle via identifying by a vehicle controller.

Referring to FIG. 19, there is illustrated a method of providing item-related information via information exchange between constituent elements 1900 and 1902 included in the vehicle, a controller 1904 of the operating apparatus, and a mobile terminal 1908 of the user. More specifically, the present embodiment has a feature in that a vehicle controller may acquire image information via repetitive identifying and may transfer the acquired image information to an operating apparatus controller, and the operating apparatus controller may manage information on an item placed in a vehicle or the user and may issue a warning to the user when the user lefts the item in the vehicle.

In step S1910, vehicle controller 1902 may repeatedly identify an event that requires for the acquisition of image information. More specifically, when a vehicle door is opened or when a trunk lid is opened, this may be sensed as an event by the vehicle controller, and the vehicle controller may control camera unit 1900 to capture an image. In addition, when an event that may cause a change in the user or the item inside the vehicle occurs, the vehicle controller may perform the following operation to acquire image information.

In step 1915, vehicle controller 1902 may request camera unit 1900 for image information corresponding to the identified event information. In one example, when the trunk lid is opened, vehicle controller 1902 may request camera unit 1900 corresponding to the trunk to capture an image.

In step 1920, camera unit 1900 may provide the requested image information to vehicle controller 1902.

In step 1925, vehicle controller 1902 may transfer the received image information to operating apparatus controller 1904.

In step 1930, operating apparatus controller 1904 may recognize image information via the received image, and may identify information regarding an item inside the vehicle and the user based on the recognized image information. In addition, operating apparatus controller 1904 may determine, based on the identified information, whether or not it is necessary to provide information to the user.

In step 1935, operating apparatus controller 1904 may provide item-related information to the mobile terminal 1908 based on the identified result.

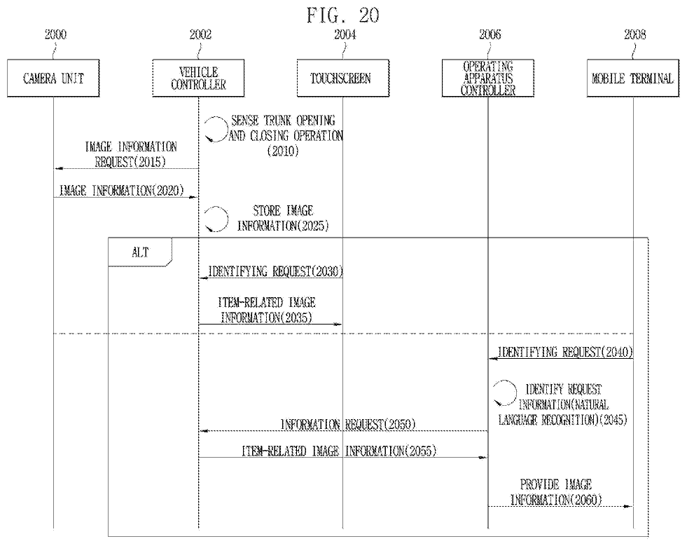

FIG. 20 is a view for explaining a method of transferring information between respective nodes for collecting information on an item placed in a vehicle and providing the information.

Referring to FIG. 20, there is illustrated a method of providing item-related information via information exchange between constituent elements 2000, 2002 and 2004 included in the vehicle, a controller 2006 of the operating apparatus, and a mobile terminal 2008 of the user. Through the embodiment, the user may manage the history of an item loaded in a vehicle based on a change when the trunk lid is opened and closed.

Steps 2010 to 2025 explain an embodiment in which vehicle controller 2002 manages the history of an item loaded in the trunk.

In step 2010, vehicle controller 2002 may sense an operation of opening and closing a trunk lid. Since a change in an item in the trunk may occur when the trunk lid is opened and closed, it is necessary to sense image information at the corresponding time.

In step 2015, vehicle controller 2002 may request camera unit 2000 for image information.

In step 2020, camera unit 2000 may provide vehicle controller 2002 with image information in response to a request.

In step 2025, vehicle controller 2002 may store the image information.

In step 2030, a identifying request for the provision of information on the item loaded in the trunk, which is input by the user via touchscreen 2004, may be additionally transferred to vehicle controller 2002. In the embodiment, the identifying request may include at least one of information regarding whether or not a specific item is in the trunk, information requesting for a current trunk image, and information requesting for the history of the item loaded in the trunk.

In step 2035, vehicle controller 2002 may provide touchscreen 2004 with image information related to the item corresponding to the request information.

In addition, in another method, in step 2040, a identifying request for the provision of information on the item loaded in the trunk, which is input by the user via mobile terminal 2008, may be transferred to operating apparatus controller 2006. In the embodiment, the identifying request may include at least one of information regarding whether or not a specific item is in the trunk, information requesting for a current trunk image, and information requesting for the history of the item loaded in the trunk. In addition, the identifying request may include a general sentence.

In step 2045, operating apparatus controller 2006 may identify request information via natural language processing. Steps 2050 and 2055 may be performed in the same manner as the above-described steps 2030 and 2035 based on the identified request information.

In step 2060, operating apparatus controller 2006 may provide mobile terminal 2008 with image information corresponding to the user's identifying request.

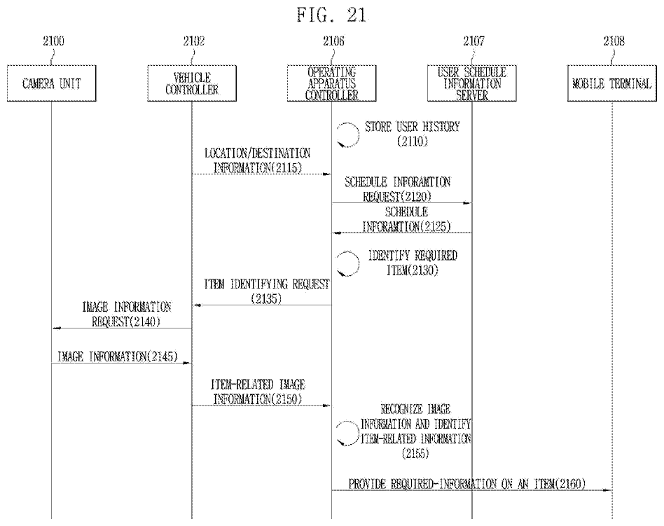

FIG. 21 is a view for explaining a method of transferring information between respective nodes for providing a user with required information on the item in consideration of information on an item placed in a vehicle based on user schedule information.

Referring to FIG. 21, there is illustrated a method of providing a user with item-related information in consideration of user schedule information via information exchange between constituent elements 2100 and 2102 included in the vehicle, a controller 2106 of the operating apparatus, a user schedule information server 2107, and a mobile terminal 2108 of the user. More specifically, this method has a feature in that information on an item stored in a vehicle may be selectively provided based on information on the vehicle use history of the user and user schedule information.

In step 2110, operating apparatus controller 2106 may store user history information in relation with the use of the vehicle. This information may include information identified by operating apparatus controller 2106 based on information related to the vehicle use history of the user received via vehicle controller 2102. In one example, information regarding the frequency with which the user takes a specific item off the vehicle at a specific location may be stored. This information on the use history of the user may be stored for each place, each time, each day, each season, and each weather type.

In step 2115, vehicle controller 2102 may provide operating apparatus controller 2106 with information on the position of the vehicle or a destination of the vehicle.

In step 2120, the operating apparatus controller may transmit a schedule information request to user schedule information server 2107. In the embodiment, the schedule information server may be realized in an external separate server, and may also be realized in a specific terminal that may perform communication. In addition, the user schedule information may include general information such as the purpose of a schedule, participants, and places.

In step 2125, user schedule information server 2107 may transmit requested user schedule information to operating apparatus controller 2106. In the embodiment, a specific time period for the provision of schedule information may be determined based on at least one of the position of the vehicle at the current time and the destination of the vehicle.

In step 2130, operating apparatus controller 2106 may identify an item required for the current schedule of the user or an item required at the destination among items in the vehicle based on the received information. The identified item may be one example of an item that is usually used at the corresponding location or an item recorded as a preparation material for the corresponding schedule.

In step 2135, operating apparatus controller 2106 may transfer an item identifying request message to vehicle controller 2102 to inquire whether or not the identified item is in the vehicle or how the current state of the item is.

In step 2140, vehicle controller 2102 may request camera unit 2100 for image information corresponding to the item, and in step 2145, camera unit 2100 may again provide the requested image information to vehicle controller 2102.

In step 2150, vehicle controller 2102 may provide item-related image information to operating apparatus controller 2106.

In step 2155, operating apparatus controller 2106 may recognize the received image information and may identify the presence or absence of the item required for the user.

In step 2160, operating apparatus controller 2106 may transmit information related to the item required for the user to mobile terminal 2108. In addition, in the embodiment, the information on the required item may also be transmitted to a display provided in the vehicle.

Alternatively, in the embodiment, operating apparatus controller 2106 may identify a required item based on information on the item placed in the vehicle after receiving image information from vehicle controller 2102.

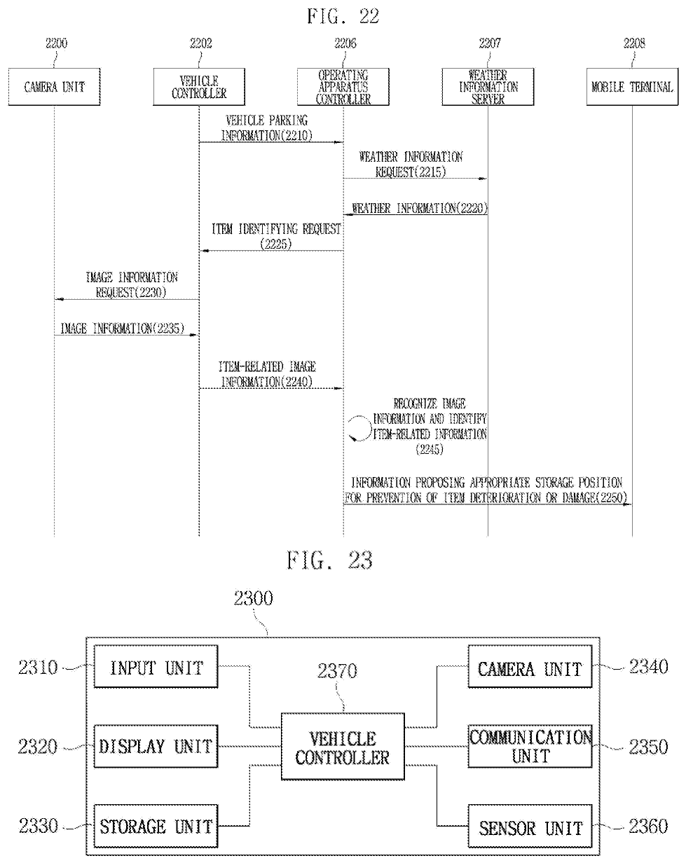

FIG. 22 is a view for explaining a method of transferring information between respective nodes for proposing an item storage position in a vehicle in consideration of information on an item in the vehicle and weather information.

Referring to FIG. 22, there is illustrated a method of providing a user with item-related information in consideration of weather information via information exchange between constituent elements 2200 and 2202 included in the vehicle, a controller 2206 of the operating apparatus, a weather information server 2207, and a mobile terminal 2208 of the user. The present invention may be applied to an embodiment in which information on an item inside a vehicle is provided to a user based on weather information at the time of parking or during parking, without a limitation thereto, and may also provide the user with related information during driving.

In step 2210, vehicle controller 2202 may provide vehicle parking information to operating apparatus controller 2206. In the embodiment, the vehicle parking information may include, for example, whether the vehicle is parked indoors or outdoors, the geographical location of the vehicle, whether the vehicle is parked in the shade when parked outdoors, and the time when the vehicle is parked. In addition, general parking-related information which may be associated with a change in the state of the vehicle may be transferred.

In step 2215, operating apparatus controller 2206 may transmit a weather information request to weather information server 2207. In the embodiment, the requested weather information may include at least one of the temperature, the humidity, cloud-related information, and rainfall information.

In step 2220, weather information server 2207 may transmit the requested weather information to operating apparatus controller 2206.

Steps 2225 to 2240 may be performed to correspond to the operation performed in steps 2135 to 2150.

In step 2245, operating apparatus controller 2206 may identify item-related information based on the image information. More specifically, operating apparatus controller 2206 may identify the item and information related thereto, and may identify the characteristics of the item and the storage period thereof, for example.

In step 2250, operating apparatus controller 2206 may provide mobile terminal 2208 of the user with information proposing an appropriate storage position for an item having a high risk of deterioration or damage based on the identified result.

FIG. 23 is a view for explaining a vehicle according to an embodiment of the present disclosure.

Referring to FIG. 23, a vehicle 2300 may include a general vehicle in which a user can usually ride and move. In the embodiment, vehicle 2300 may include an input unit 2310, a display unit 2320, a storage unit 2330, a camera unit 2340, a communication unit 2350, a sensor unit 2360, and a vehicle controller 2370 which controls the sensor unit.

Input unit 2310 may receive user input, and display unit 2320 may display information related to an operation of vehicle 2300. In one example, input unit 2310 and display unit 2320 may be realized in a touchscreen.

Storage unit 2330 may store at least one of information generated in the vehicle and information transmitted to and received from communication unit 2350.

Camera unit 2340 may capture an image of the inside and/or the outside of the vehicle to generate image information. In some embodiments, camera unit 2340 may capture a moving image.

Communication unit 2350 may be configured to communicate with other nodes, and may also be configured to communicate with specific servers, a 5G server, and a user terminal, for example.

Sensor unit 2360 may sense several physical values to be sensed in the vehicle. In the embodiment, sensor unit 2360 may include a temperature sensor, a luminous intensity sensor, a humidity sensor, and an acceleration sensor.

Vehicle controller 2370 may control a general operation of the vehicle, and may control a vehicle operation related to the methods described in the above embodiments.

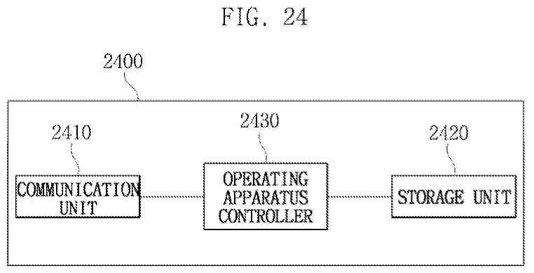

FIG. 24 is a view for explaining an operating apparatus for the provision of information according to an embodiment of the present disclosure.

Referring to FIG. 24, an operating apparatus 2400 is an apparatus that performs the operations described in the embodiments of the present disclosure. Operating apparatus 2400 may be an independent apparatus, may be provided in the vehicle, or may be located on a specific server. The operating apparatus may be located in a user terminal according to a realization manner. Operating apparatus 2400 of the embodiment may include a communication unit 2410, a storage unit 2420, and an operating apparatus controller 2430 which controls the aforementioned units.

Communication unit 2410 may perform wired or wireless communication with other nodes in the embodiment, and the transmission and reception of information may be performed via communication unit 2410.

Storage unit 2420 may store information generated in operating apparatus 2400 and information transmitted and received via communication unit 2410.

Operating apparatus controller 2430 may control an operation of the entire operating apparatus, and may control an operation of the operating apparatus related to the methods described in the embodiments.

Throughout the embodiments, an instruction input to the operating apparatus by the user may take a sentence form, and the operating apparatus may identify the instruction using natural language processing, for example.

Throughout the specification, the operating apparatus may be located in a separate server which may communicate with the vehicle, without a limitation thereto. The operating apparatus may be provided in the vehicle or may be provided in a user terminal. In addition, information used in the operating apparatus may be received from at least one of the vehicle, the user terminal, and an external server.

Throughout the specification, image information may be replaced with moving image information. With this replacement, the user may receive moving image information along with sound. In addition, nevertheless to say, a microphone unit may be provided in the vehicle to provide the moving image information described above.

Although the exemplary embodiments of the present disclosure have been described in this specification with reference to the accompanying drawings and specific terms have been used, these terms are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of providing information from an operating apparatus, the method comprising:
acquiring image information related to an inside of a vehicle;
identifying information on an item placed inside the vehicle by a user based on the image information; and
identifying information on a target for providing information based on the identified information on the item.

2. The method of claim 1, wherein the information for the target for providing information is determined based on the information on the item and information related to a position of the vehicle.

3. The method of claim 2, wherein the information related to the position of the vehicle is determined based on a physical position of the vehicle and information related to the user.

4. The method of claim 3, wherein the information related to the user includes at least one of information on a residence of the user, information on a workplace of the user, and information on a schedule of the user.

5. The method of claim 2, wherein the information for the target for providing information includes information on a position at which the vehicle and the user meet each other that is identified based on the information on the item, the information related to the position of the vehicle, and information related to a position of the user.

6. The method of claim 5, wherein the information for the target for providing information is determined based on traffic information of an area corresponding to the information on the position at which the vehicle and the user meet each other.

7. The method of claim 1, wherein the information for the target for providing information is determined based on at least one of weather forecast information and information on a temperature inside the vehicle.

8. The method of claim 7, wherein the information on the temperature inside the vehicle includes information on temperatures at a plurality of positions inside the vehicle, and
wherein the information for the target for providing information includes a storage place of the item placed inside the vehicle that is identified based on the information on the item and the temperature information.

9. The method of claim 1, wherein the information on the item includes information regarding whether the identified item is an item that is temporarily placed inside the vehicle or an item that is normally placed in the vehicle.

10. The method of claim 1, wherein the information for the target for providing information includes at least one of information regarding a time period during which the identified item is placed in the vehicle, information regarding a time when the identified item is removed to an outside of the vehicle, user information related to the identified item, and information regarding a current position of the identified item inside the vehicle.

11. The method of claim 1, wherein the information on the identified item includes information regarding whether or not the item is firstly placed inside the vehicle and a frequency with which the item is placed inside the vehicle.

12. The method of claim 1, wherein the information for the target for providing information is identified based on a driving state of the vehicle.

13. The method of claim 1, wherein the operating apparatus is provided in the vehicle, or is provided in a separate apparatus that is capable of communicating with the vehicle.

14. An operating apparatus comprising:
a communication unit configured to communicate with another apparatus; and
a controller configured to acquire image information on an inside of a vehicle, to identify information on an item placed inside the vehicle by a user based on the image information, and to identify information for an target for providing information based on the identified information on the item.

15. A non-volatile storage medium that stores an instruction for executing the method of claim 1.
